(19) United States
(12) Patent Application Publication
(10) Pub. No.: US 2006/0262045 A1
(43) Pub. Date: Nov. 23, 2006

(54) Plasma display and driver

(76) Inventor: Hye-Kwang Park, Suwon-si (KR)

Correspondence Address: Robert E. Bushnell, Suite 300, 1522 K Street, N.W., Washington, DC, 20005-1202, US

(21) Appl. No.: 11/337,559

(22) Filed: Jan. 24, 2006

(30) Foreign Application Priority Data
May 23, 2005 (KR) 10-2005-0042934
Oct. 18, 2005 (KR) 10-2005-0098032

(51) Int. Cl. G09G 3/28

(52) U.S. Cl. 345/68

(57) ABSTRACT

A plasma display includes: a plurality of electrodes extending in one direction; at least one inductor coupled between the plurality of electrodes and a power recovery power source; a first transistor coupled either between the at least one inductor and the electrode or between the at least one inductor and the power recovery power source; a second transistor coupled either between the at least one inductor and the electrode or between the at least one inductor and the power recovery power source; and a gate driving circuit adapted to supply either a high or low level voltage to a gate of either the first or second transistor, and including a Light Emitting Diode (LED) adapted to emit light in response to a current flow to the gate, and a first diode coupled to the LED in reverse parallel.

### CLAIM OF PRIORITY

This application makes reference to, incorporates the same herein, and claims all benefits accruing under 35 U.S.C. §119 from applications for PLASMA DISPLAY DEVICE AND DRIVING APPARATUS THEREOF earlier filed in the Korean Intellectual Property Office on 23 May 2005 and 18 Oct. 2005, and there duly assigned Serial Nos. 10-2005-0042934, and 10-2005-0098032, respectively.

### BACKGROUND OF THE INVENTION

1. Field of the Invention

The present invention relates to a plasma display and driver.

2. Description of the Related Art

A plasma display is a flat panel display that uses a plasma generated by a gas discharge to display characters or images. It includes a Plasma Display Panel (PDP) wherein tens to millions of pixels are provided in a matrix format, depending on its size.

According to a typical method of driving a PDP, each frame is divided into a plurality of subfields having respective brightness weight values, and displayed images are represented by a combination of the subfields. Each subfield has a reset period, an address period, and a sustain period.

The reset period is for initializing states of respective discharge cells so as to facilitate an addressing operation on the discharge cell. The address period is for selecting turned-on/turned-off cells (i.e., cells to be turned on or off) and accumulating wall charges on the turned-on cells (i.e., addressed cells). The sustain period is for sustain-discharging the addressed cell for a period corresponding to a weight value of a corresponding subfield.

Such a sustain discharge is caused when a sustain pulse is alternately supplied to two electrodes. To apply the sustain pulse to the two electrodes, it is necessary to provide an additional reactive power as well as a power for the sustain discharge since the two electrodes operate as a capacitive load (hereinafter, referred to as a panel capacitor). Therefore, a typical sustain discharge driving circuit includes a power recovery circuit for recovering and reusing the reactive power.

However, when the power recovery circuit is not driven, a switch for supplying the sustain pulse can deteriorate due to heat caused by a hard switching of the switch since the sustain discharge is still being generated even though the power recovery is not being performed.

Therefore, it is necessary to provide a method of easily determining whether the power recovery circuit is being driven.

### SUMMARY OF THE INVENTION

The present invention has been made in an effort to provide a plasma display and driver having an advantage of easily determining a malfunctioning of a power recovery circuit.

An exemplary plasma display device according to one embodiment of the present invention includes: a plurality of electrodes extending in one direction; at least one inductor coupled between the plurality of electrodes and a power recovery power source; a first transistor coupled either between the at least one inductor and the electrode or between the at least one inductor and the power recovery power source; a second transistor coupled either between the at least one inductor and the electrode or between the at least one inductor and the power recovery power source; and a gate driving circuit adapted to supply either a high or low level voltage to a gate of either the first or second transistor, and including a Light Emitting Diode (LED) adapted to emit light in response to a current flow to the gate, and a first diode coupled to the LED in reverse parallel.

The gate driving circuit preferably further includes an amplifier adapted to output either the high level voltage or the low level voltage in response to a signal to control the transistor, and the LED and the first diode are preferably coupled in parallel between the amplifier and the gate of either the first transistor or the second transistor. The gate driving circuit preferably further includes a first capacitor having a first terminal coupled to the amplifier and a second terminal coupled to the gate of either the first or the second transistor and a source thereof; and the LED is preferably coupled either between the amplifier and the capacitor or between the amplifier and the gate.

The LED preferably includes an anode coupled to the amplifier and a cathode coupled to the gate of either the first or the second transistor and the source thereof; and the first diode preferably includes a cathode coupled to the amplifier and an anode coupled to the gate of either the first or the second transistor and the source thereof.

The amplifier preferably includes a third transistor and a fourth transistor coupled between a first power source adapted to supply a first voltage and a second power source adapted to supply a second voltage, the third and fourth transistors arranged as a push-pull circuit; and the amplifier is preferably adapted to supply a driving voltage to the gate of either the first or the second transistor through the push-pull circuit.

One of the third and fourth transistors preferably includes an NPN transistor and the other of the third and fourth transistors includes a PNP transistor.

The plasma display preferably further includes: a first resistor coupled between the second terminal of the first capacitor and the gate of either the first or the second transistor; and a second resistor coupled between the second terminal of the first capacitor and the source of either the first or the second transistor.

The plasma display preferably further includes a second capacitor coupled between the second terminal of the first capacitor and the source of either the first or the second transistor. The plasma display preferably further includes a third resistor coupled between the first terminal of the first capacitor and the second power source.

The plasma display preferably further includes a third capacitor having a first terminal adapted to supply the first voltage of the first power source and a second terminal to supply the second voltage of the second power source, the second terminal being coupled to the source of either the first or the second transistor, and the third capacitor preferably being charged to a voltage corresponding to a difference between the first voltage and the second voltage. The plasma display preferably further includes a second diode coupled between the first terminal of the third capacitor and the amplifier.

The plasma display preferably further includes: a fifth transistor coupled between the electrode and a third power source adapted to supply a third voltage; and a sixth transistor coupled between the electrode and a fourth power source adapted to supply a fourth voltage lower than the third voltage; the power recovery power source is preferably adapted to supply a voltage between the third voltage and the fourth voltage. The second voltage is preferably of the same voltage level as that of the fourth voltage.

The first and second transistors preferably respectively include a body diode, and the plasma display device preferably further includes: a second diode coupled to the first transistor in series in a reverse direction to the body diode thereof; and a third diode coupled to the second transistor in series in a reverse direction to the body diode thereof.

An exemplary plasma display device according to another embodiment of the present invention includes: a plurality of electrodes extending in one direction; at least one inductor coupled between the plurality of electrodes and a power recovery power source; a first transistor coupled between either the at least one inductor and the electrode or between the at least one inductor and the power recovery power source; a second transistor coupled between either the at least one inductor and the electrode or between the at least one inductor and the power recovery power source; and a gate driving circuit preferably adapted to supply either a high or low level voltage to a gate of either the first or second transistor, and including a Light Emitting Diode (LED) preferably coupled between the gate and the source of either the first or second transistor and preferably adapted to emit light in response to a current flow to the gate.

The gate driving circuit preferably further includes an amplifier adapted to output either the high level voltage or the low level voltage in response to a signal to control the transistor; and wherein the LED is coupled between the amplifier and the source. The gate driving circuit preferably further includes: a first capacitor having a first terminal coupled to the amplifier and a second terminal coupled to the gate and a source of either the first or the second transistor; and a first resistor preferably coupled to the second terminal of the first capacitor and the source of either the first or the second transistor.

A cathode of the LED is preferably coupled to the source of either the first or the second transistor, and an anode of the LED is coupled to the second terminal of the first capacitor.

The plasma display preferably further includes: a second resistor coupled between the second terminal of the first capacitor and the gate of either the first or the second transistor; and a third resistor coupled between the second terminal of the first capacitor and the source of either the first or the second transistor.

The plasma display device preferably further includes a second capacitor coupled between the second terminal of the first capacitor and the source of either the first or the second transistor.

The plasma display preferably further includes a Zener diode coupled between the LED and the source of either the first or the second transistor. The Zener diode preferably has a cathode coupled to the cathode of the LED and an anode coupled to the source of either the first or the second transistor.

The plasma display preferably further includes a fourth resistor coupled between the first terminal of the first capacitor and the ground power source. The plasma display preferably further includes a third capacitor having a first terminal adapted to supply the first voltage of the first power source to a high level power input terminal of the amplifier and a second terminal to supply the second voltage of the second power source to a low level power input terminal of the amplifier; the capacitor is preferably charged to a voltage corresponding to a difference between the first voltage and the second voltage; and the second terminal of the capacitor is preferably coupled to the source of either the first or second transistor.

An exemplary driver for driving a plasma display having a plurality of electrodes extending in a single direction according to another embodiment of the present invention includes: a gate driving circuit including: at least one inductor coupled to the plurality of electrodes; a first transistor coupled to the at least one inductor and adapted to increase a voltage at the electrode when the first transistor is turned on; a second transistor coupled to the at least one inductor and adapted to reduce the voltage at the electrode when the second transistor is turned on; a Light Emitting Diode (LED) coupled to a gate of either the first or the second transistor and adapted to emit light in response to either the first or the second transistor being turned on; and a diode coupled to the gate of either the first or the second transistor, the diode being coupled in reverse parallel with the LED.

The gate driving circuit preferably further includes an amplifier adapted to receive a signal to control a turn on of either the first or the second transistor, to control an output a predetermined voltage, and to control the emission of light from the LED.

The driver preferably further includes: a third transistor adapted to be turned on in response to the voltage at the electrode being increased, the third transistor preferably supplying a first voltage to the electrode; and a fourth transistor turned adapted to be turned on in response to the voltage at the electrode being reduced, the fourth transistor preferably supplying a second voltage which is less than the first voltage. The driver preferably further includes: a third transistor adapted to be turned on in response to the voltage at the electrode being increased, the third transistor preferably supplying a first voltage to the electrode; and a fourth transistor turned adapted to be turned on in response to the voltage at the electrode being reduced, the fourth transistor preferably supplying a second voltage which is less than the first voltage. The driver preferably further includes a capacitor adapted to be charged to a voltage between the first voltage and the second voltage, the capacitor being preferably coupled between the first transistor and the second transistor. The driver preferably further includes a capacitor adapted to be charged to a voltage between the first voltage and the second voltage, the capacitor being coupled between the first transistor and the second transistor.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic diagram of a plasma display according to an exemplary embodiment of the present invention.

FIG. 2 are views of driving waveforms in a sustain period of the plasma display according to the exemplary embodiment of the present invention.

FIG. 3 is a schematic diagram of a sustain discharge driving circuit according to the exemplary embodiment of the present invention.

FIG. 4 is a schematic diagram of a sustain discharge driving circuit according to another exemplary embodiment of the present invention.

FIG. 5 is a view of a driving waveform of a power recovery circuit according to the exemplary embodiment of the present invention.

FIG. 6 is a schematic diagram of a gate driving circuit according to a first exemplary embodiment of the present invention.

FIG. 7 is a schematic diagram of a push-pull amplifier according to the exemplary embodiment of the present invention.

FIG. 8 is a schematic diagram of a gate driving circuit according to a second exemplary embodiment of the present invention.

FIG. 9 is a schematic diagram of a gate driving circuit according to a third exemplary embodiment of the present invention.

FIG. 10 is a schematic diagram of a gate driving circuit according to a fourth exemplary embodiment of the present invention.

FIG. 11 is a schematic diagram of a gate driving circuit according to a fifth exemplary embodiment of the present invention.

### DETAILED DESCRIPTION OF THE INVENTION

In the following detailed description, exemplary embodiments of the present invention have been shown and described, simply by way of illustration. As those skilled in the art would realize, the described embodiments can be modified in various different ways, all without departing from the spirit or scope of the present invention.

Accordingly, the drawings and description are to be regarded as illustrative in nature and not restrictive. Like reference numerals designate like elements throughout the specification.

“Wall charges” are charges formed on a wall close to each electrode of a discharge cell and accumulated on the electrode. The wall charges are described as being “formed” or “accumulated” on an electrode, although the wall charges do not actually touch the electrode. Furthermore, a “wall voltage” is a potential difference formed on the wall of the discharge cell by the wall charges.

A plasma display and driver according to an exemplary embodiment of the present invention is described below with reference to the figures.

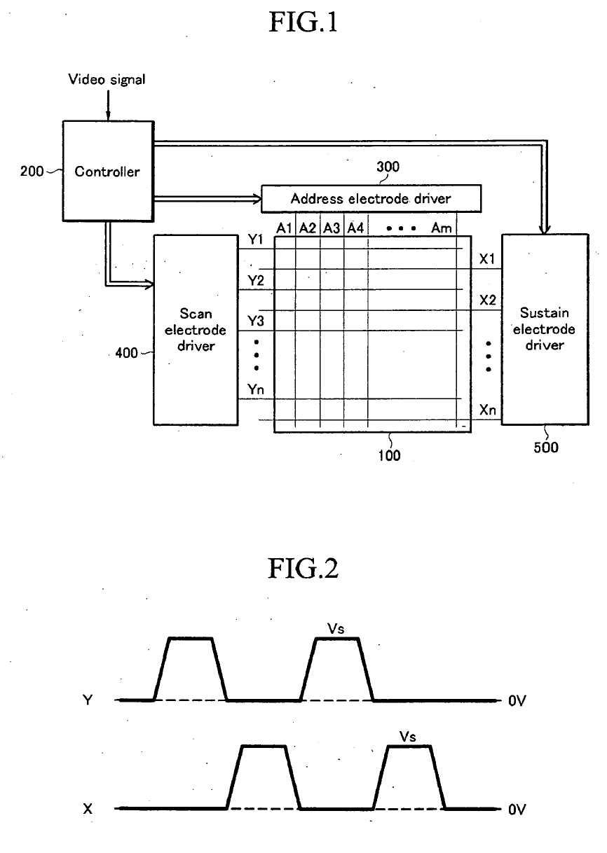

FIG. 1 is a schematic diagram of the plasma display according to an exemplary embodiment of the present invention.

As shown in FIG. 1, the plasma display includes a Plasma Display Panel (PDP) 100, a controller 200, an address electrode driver 300, a scan electrode driver 400, and a sustain electrode driver 500.

The PDP 100 includes a plurality of address electrodes A1-Am (hereinafter, referred to as A electrodes) extending in the column direction, and scan electrodes Y1-Yn (hereinafter, referred to as Y electrodes) and sustain electrodes X1-Xn (hereinafter, referred to as X electrodes) extending in the row direction.

A discharge cell ( hereinafter, referred to as a cell) is formed by a discharge space formed at a crossing region of one of the address electrodes A1-Am and a pair of electrodes consisting of one of the scan electrodes Y1-Yn and one of the sustain electrodes X1-Xn.

The controller 200 externally receives video signals, and outputs an address driving control signal, a sustain electrode driving control signal, and a scan electrode driving control signal. In addition, the controller 200 operates by a plurality of subfields divided from one frame, and each subfield includes a reset period, an address period, and a sustain period.

The address driver 300 receives the address driving control signal from the controller 200, and supplies a display data signal for selecting turned-on discharge cells (i.e., discharge cells to be turned on) to the respective address electrodes.

The scan electrode driver 400 receives the scan electrode driving signal from the controller 200, and supplies a driving voltage to the scan electrode.

The sustain electrode driver 500 receives the sustain electrode driving control signal from the controller 200, and supplies the driving voltage to the sustain electrode.

Driving waveforms in the sustain period of the plasma display panel according to the exemplary embodiment of the present invention are described below with reference to FIG. 2.

FIG. 2 are views of driving waveforms in the sustain period of the plasma display according to an exemplary embodiment of the present invention. The driving waveforms supplied to the X and Y electrodes in the sustain period of one subfield are illustrated in FIG. 2.

As shown in FIG. 2, the sustain pulse alternately having a voltage Vs and 0V is supplied to the X and Y electrodes in the sustain period, and the sustain pulse supplied to the X electrode has an opposite phase to that of the sustain pulse supplied to the Y electrode. Accordingly, a voltage difference between the X and Y electrodes alternately becomes the voltage Vs and a voltage −Vs.

When a predetermined wall voltage is formed between the X and Y electrodes in the address period, a discharge is generated by the wall voltage and the voltage difference Vs supplied to the two electrodes. The wall voltage at the two electrodes is shifted to the opposite polarity by the generated discharge, and another discharge is generated by an opposite polarity voltage difference of −Vs supplied to the two electrodes. Then, an image is displayed after the above operation of generating the discharge is repeatedly performed for the number of times corresponding to the weight value of the corresponding subfield.

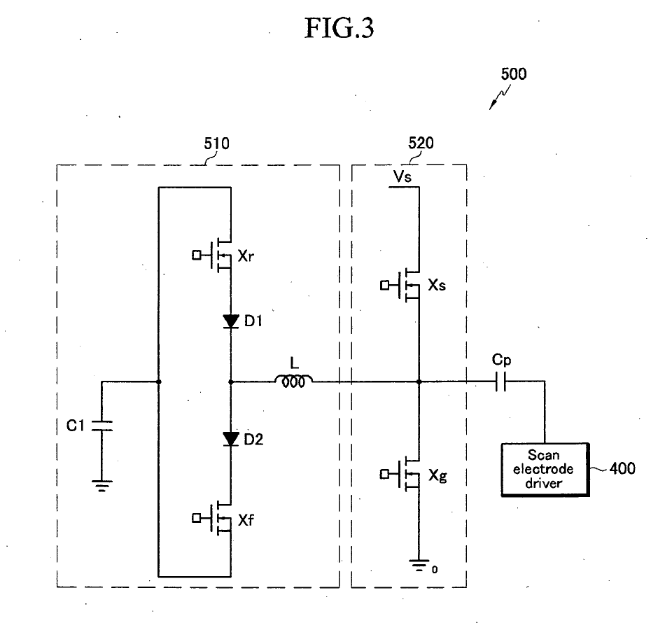

A power recovery circuit for generating the sustain pulse shown in FIG. 2 is described below with reference to FIG. 3 to FIG. 5.

FIG. 3 is a schematic diagram of a sustain discharge driving circuit according to the exemplary embodiment of the present invention.

The transistors in FIG. 3 are illustrated as being n-channel Field Effect Transistors (FETs) having a body diode (not shown). A cathode of the body diode is coupled to a drain of the transistor, and an anode of the body diode is coupled to a source of the transistor. Such transistors can be replaced by other switches having equal or similar functions. In addition, the respective transistors of FIG. 3 can be a plurality of transistors coupled in parallel. In FIG. 3, a capacitance formed by the X and Y electrodes is illustrated as a panel capacitor Cp, and the sustain discharge driving circuit coupled to the X electrode is illustrated for better comprehension and ease of description.

As shown in FIG. 3, the sustain discharge driving circuit according to the exemplary embodiment of the present invention includes a power recovery circuit 510 and a sustain voltage driver 520.

The power recovery circuit 510 includes transistors Xr and Xf, an inductor L, diodes D1 and D2, and a power recovery capacitor C1.

A first terminal of the inductor L is coupled to a sustain electrode X of the panel capacitor Cp, and a second terminal of the inductor L is coupled to a cathode of the diode D1. An anode of the diode D1 is coupled to a source of the transistor Xr and a drain of the transistor Xr is coupled to the power recovery circuit capacitor C1.

The second terminal of the inductor L is also coupled to an anode of the diode D2. A cathode of the diode D2 is coupled to a drain of the transistor Xf, and a source of the transistor Xf is coupled to the power recovery capacitor C1.

A voltage Vs/2 corresponding to a half of a difference between the voltage Vs and 0V is stored in the power recovery capacitor C1.

The diode D1 breaks a path formed from the inductor L to the power recovery capacitor C1 through the body diode of the transistor Xr when the transistor Xr has the body diode. In a like manner, the diode D2 breaks a path formed from the power recovery capacitor C1 to inductor L through the body diode of the transistor Xf when the transistor Xf has the body diode. When the switches Xr and Xf have no body diode, the diodes D1 and D2 can be eliminated.

The power recovery circuit 510 of the above configuration charges the panel capacitor Cp up to the voltage Vs or discharges the panel capacitor Cp to a ground voltage.

In addition, orders of a connection between the diode D1 and the transistor Xr and a connection between the diode D2 and the transistor Xf can be changed in the power recovery circuit 510.

The sustain voltage driver 520 is coupled to the sustain electrode X of the panel capacitor Cp, and includes two transistors Xs and Xg. The transistor Xs is coupled between a power source supplying a sustain discharge voltage Vs and the sustain electrode X of the panel capacitor Cp, and the transistor Xg is coupled between a power source supplying the ground voltage and the panel capacitor Cp. The transistors Xs and Xg respectively supply the voltage Vs and the ground voltage to the panel capacitor Cp.

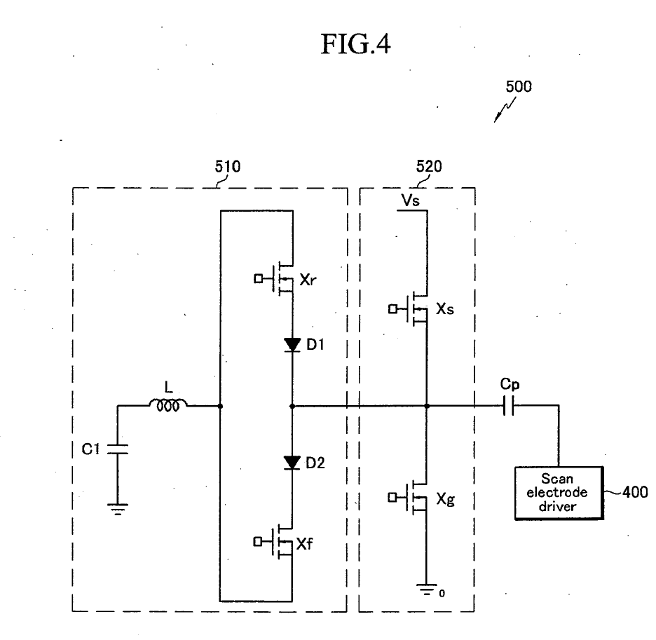

As shown in FIG. 4, the inductor L can be coupled between the power recovery capacitor C1 and the transistors Xr and Xf.

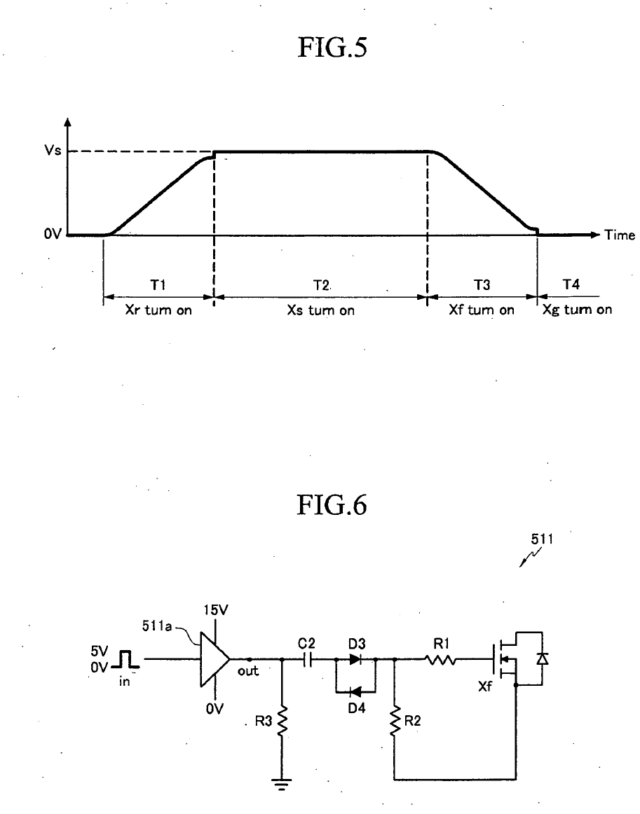

The operation of the driving circuit of FIG. 3 is described below with reference to FIG. 5.

As shown in FIG. 5, in a period T1, the transistor Xg is turned off when the X electrode voltage Vx of the panel capacitor Cp is 0V, and the X electrode voltage Vx of the panel capacitor Cp is increased since a resonance current flows to the capacitor C1, the transistor Xr, the diode D1, the inductor L, and the panel capacitor Cp when the transistor Xr is turned on. That is, the transistor Xr and the diode D1 form a voltage rising path for increasing a voltage at the panel capacitor Cp. While the X electrode voltage Vx can be theoretically increased up to the voltage Vs which is double the voltage at the power recovery capacitor C1, it can also be increased to a voltage which is less than the voltage Vs due to parasitic components in the circuit. Subsequently, the transistor Xs is turned on and the voltage Vs is supplied to the X electrode of the panel capacitor in a period T2.

In a period T3, when the transistor Xs is turned off and the transistor Xf is turned on, the X electrode voltage Vx of the panel capacitor Cp is reduced since a resonance current flows to the panel capacitor Cp, the inductor L, the diode D2, the transistor Xf, and the capacitor C1. That is, the transistor Xf and the diode D2 form a voltage falling path for reducing the voltage at the panel capacitor Cp. While the X electrode voltage Vx can be theoretically reduced to 0V, it can also be reduced to a voltage which is higher than 0V due to the parasitic components in the circuit. Subsequently, in a period T4, the transistor Xg is turned on and 0V is supplied to the X electrode of the panel capacitor Cp.

Since the transistors Xr, Xs, Xf, and Xg are turned on and turned off as described above so that the periods T1 to T4 are repeated, the sustain pulse of FIG. 3 can be supplied to the X electrode. In addition, while one inductor L is illustrated in FIG. 4, two different inductors can be respectively coupled between the voltage rising path and the X electrode and between the voltage falling path and the X electrode.

A gate driving circuit 511 coupled to a gate of the transistor Xr or Xf to determine an operation state of the power recovery circuit 510 is described below with reference to FIG. 6.

Since the respective gate driving circuits coupled to the respective gates of the transistors Xr and Xf are the same, only the gate driving circuit coupled to the transistor Xf is described below.

FIG. 6 is a schematic diagram of a gate driving circuit according to a first exemplary embodiment of the present invention.

In FIG. 6, a control signal in swings between 0V and 5V and an amplifier 511a outputs a signal swinging between 0V and 15V in response to the control signal in.

As shown in FIG. 6, the gate driving circuit 511 according to the first exemplary embodiment of the present invention includes the amplifier 511a, a capacitor C2, a Light Emitting Diode (LED) D3, a diode D4, and resistors R1 and R2. The amplifier 511a outputs a high level voltage or a low level voltage for driving the gate of the transistor Xf in response to the control signal in. In general, the control signal in is output from the controller 200 to control a turn on/turn off operation of the transistor Xf, and has a low voltage level which is used in the controller 200. However, because the turning on/off operation of the transistor Xf cannot be controlled by the voltage level of the control signal in, the amplifier 511a for amplifying the voltage level of the control signal in is used. For example, a push-pull amplifier can be used.

The amplifier 511a has a high level power source input terminal coupled to 15V and a low level power source input terminal coupled to 0V. The capacitor C2 is coupled between an output terminal of the amplifier 511a and the gate of the transistor Xf, and is charged to the voltage Vs/2 in response to a low output voltage of the amplifier 511a. In addition, the LED D3 and the diode D4 are coupled to each other in parallel between the gate of transistor Xf and the amplifier 511a. The diode D4 is coupled in a reverse direction to that of the LED D3.

That is, an anode of the LED D3 is coupled to a second terminal of the capacitor C2, and a cathode thereof is coupled to the gate of the transistor Xf. In addition, a cathode of the diode D4 is coupled to a second terminal of the capacitor C2, and an anode thereof is coupled to the gate of the transistor Xf.

The resistors R1 and R2 can be respectively coupled between the gate of the transistor Xf and the capacitor C2, and between a source of the transistor Xf and the capacitor C2 in order to prevent a sudden voltage change. In addition, a resistor R3 may be coupled between a first terminal of the capacitor C2 and a ground power source in order to prevent the sudden voltage change.

The operation of the gate driving circuit 511 of FIG. 6 is described below.

When the control signal in becomes 5V to reduce the X electrode voltage Vx of the panel capacitor Cp in the period T3 of FIG. 5, the output voltage out of the amplifier 511a becomes 15V. Since the capacitor C1 has been charged to the voltage Vs/2, a voltage (15+Vs/2) corresponding to a sum of the voltage Vs/2 and 15V is supplied to the gate of the transistor Xf. Then, since a gate-source voltage of the transistor Xf is 15V which is greater than a threshold voltage, the transistor Xf is turned on when the transistor Xf is in a normal state. Therefore, the LED D3 emits light since a current flows to the gate of the transistor Xf from the amplifier 511a through the LED D3.

In this case, however, the transistor Xf is not driven when the transistor Xf has deteriorated. Therefore, when the control signal in is 5V, the LED D3 emits no light since a current path is not formed between the amplifier 511a and the gate of the transistor Xf.

In addition, when the control signal in is 0V, the output voltage out of the amplifier 511a becomes 0V. In this case, the current flows to the ground power source through the diode D4 and the resistor R3 since the gate-source voltage of the transistor Xf is 0V.

According to the first exemplary embodiment of the present invention, an operation state of the transistor Xf can be determined by a light emitting state of the LED. Therefore, the LED D3 and the diode D4 coupled in parallel can be provided between the output terminal of the amplifier 511a and the capacitor C2 or between the gate of the transistor Xf and the resistor R1.

In the exemplary embodiment of the present invention, the amplifier 511a is used to amplify the voltage level of the control signal in, and a push-pull amplifier can be used for the amplifier 511a.

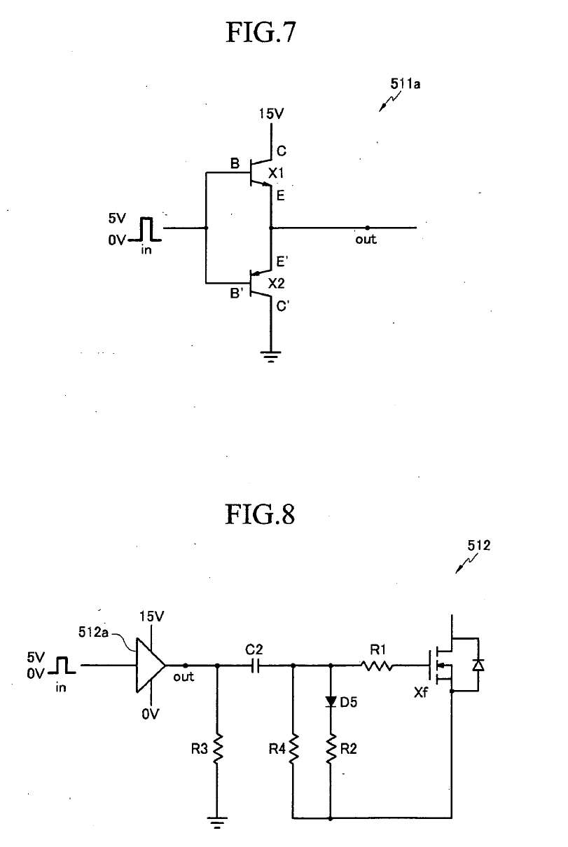

FIG. 7 is a schematic diagram of push-pull amplifier constituting the amplifier 511a according to the exemplary embodiment of the present invention.

As shown in FIG. 7, an NPN transistor X1 and a PNP transistor X2 form a push-pull circuit 511a, and the push-pull circuit 511a outputs a voltage of 15V or 0V in response to the control signal in inputted through bases B and B′ coupled to each other.

In more detail, a high level power source input terminal (i.e., a collector C of the NPN transistor X1) of the push-pull circuit 511a is coupled to a power source supplying 15V, and a low level power source input terminal (i.e., a collector C′ of the PNP transistor X2) thereof is coupled to a ground power source. An emitter E of the NPN transistor X1 and an emitter E′ of the PNP transistor X2 is coupled to an output terminal out of the push-pull circuit 511a.

Therefore, when a 5V control signal is input through an input terminal in of the push-pull circuit 511a, the transistor Xf is turned on since a voltage amplified to 15V is generated through the output terminal out. When a 0V control signal is input through the input terminal, the transistor Xf is turned off since a 0V signal is generated through the output terminal out.

In addition to the gate driving circuit according to the first exemplary embodiment of the present invention, a different type of gate driving circuit can be realized when the LED is coupled between the amplifier 511a and the gate of the transistor Xf as shown in FIG. 6.

FIG. 8 is a schematic diagram of a gate driving circuit according to a second exemplary embodiment of the present invention. In FIG. 8, the gate driving circuit coupled to the transistor Xf of the two transistors Xr and Xf is illustrated for convenience of description.

In addition, the control signal in swings between 0V and 5V, and the amplifier 512a outputs a signal swinging between 0V and 15V in response to the control signal in. A description of elements that have already been described has been omitted here for the sake of brevity.

As shown in FIG. 8, a gate driving circuit 512 according to the second exemplary embodiment of the present invention includes an amplifier 512a, a capacitor C2, an LED D5, and resistors R1, R2, R3, and R4. The capacitor C2 is coupled between an output terminal out of the amplifier 512a and the gate of the transistor Xf. In addition, the resistor R3 is coupled between a first terminal of the capacitor C2 and a ground power source, and the resistor R4 is coupled between a second terminal of capacitor C2 and a source of the transistor Xf. Accordingly, when 0V is output through the output terminal out of the gate driving circuit 512, the capacitor C2 is charged to a source voltage of the transistor Xf through the resistor R4, capacitor C2, and the ground power source. In addition, the LED D5 and the resistor R2 is coupled between the second terminal of the capacitor C2 and the source of the transistor Xf.

Furthermore, the resistor R1 is coupled between the gate of the transistor Xf and the second terminal of the capacitor C2, and the resistors R1, R2, and R3 prevent the sudden voltage change in the capacitor C2. The operation of the gate driving circuit 512 of FIG. 8 is described below.

When the control signal in is 5V in the period T3 of FIG. 3, 15V is output to the output terminal out through the amplifier 512a. Since the capacitor C2 has been charged to the source voltage Vs/2 of the transistor Xf, the gate voltage of the transistor Xf is increased to a voltage (15V+Vs/2) corresponding to a sum of 15V and the source voltage of the transistor Xf. Then, since the gate-source voltage of the transistor Xf is 15V which is greater than the threshold voltage, the transistor Xf is turned on when it is in the normal state. Therefore, the LED D5 emits light since a current flows from the amplifier 512a to the source of the transistor Xf. The transistor Xf is not driven when the transistor Xf has deteriorated. Therefore, a current path from the amplifier 512a to the gate of the transistor Xf is not formed, and the LED D5 does not emit light.

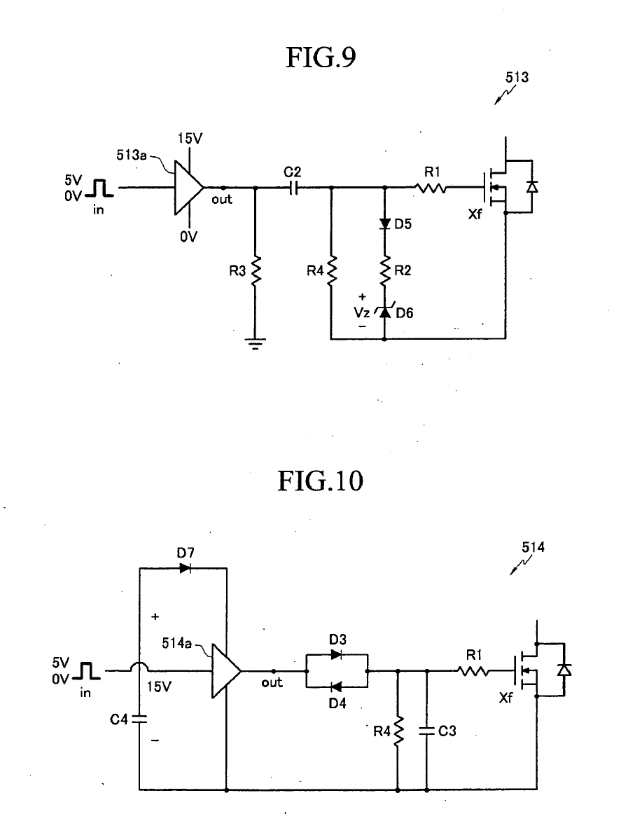

FIG. 9 is a schematic diagram of a gate driving circuit according to a third exemplary embodiment of the present invention.

As shown in FIG. 9, the gate driving circuit 513 according to the third exemplary embodiment includes an amplifier 513a, a capacitor C2, an LED D5, and resistors R1, R2, R3, and R4. A configuration of the gate driving circuit 513 according to the third exemplary embodiment is the same as that shown in FIG. 8 except for a Zener diode D6 coupled between the LED D5 and the source of the transistor Xf. The operation of the gate driving circuit 513 is the same as that of the second exemplary embodiment of the present invention, and therefore detailed descriptions thereof have been omitted. The voltage across the terminals of the LED D5 is reduced by a voltage corresponding to a breakdown voltage Vz of the Zener diode D6 when the Zener diode D6 is coupled between the LED D5 and the source of the transistor Xf. Accordingly, when the resistor R2 is not provided, a voltage (15V−Vz) is supplied across the terminals of the LED D5.

Therefore, the load is reduced when the LED D5 emits light, and the manufacturing cost can be reduced since an LED D5 having a low voltage can be used.

FIG. 10 is a schematic diagram of a gate driving circuit according to a fourth exemplary embodiment of the present invention.

As shown in FIG. 10, the gate driving circuit 514 according to the fourth exemplary embodiment of the present invention includes an amplifier 514a, capacitors C3 and C4, an LED D3, diodes D4 and D7, and resistors R1 and R2. In a like manner to the first exemplary embodiment of the present invention, the LED D3 and the diode D4 are coupled to each other in parallel between the amplifier 514a and the output terminal out of the transistor Xf. The diode D4 is coupled in an opposite polarity to the LED D3. In addition, the capacitor C3 is coupled between the gate of the transistor Xf and a low level power source input terminal of the amplifier 514a.

Furthermore, the resistors R1 and R2 are respectively coupled between the gate of the transistor Xf and the output terminal, and between the source of the transistor Xf and the output terminal out in order to prevent a sudden voltage change. A first terminal of the capacitor C4 is coupled to a high level power source input terminal of the amplifier 514a through the diode D7, and a second terminal of the capacitor C4 is coupled to the low level power source input terminal of the amplifier 514a.

The capacitor C4 is charged to 15V, and the second terminal of the capacitor C4 and the low level power source input terminal of the amplifier 514a are coupled to the source of the transistor Xf. Therefore, a voltage supplied to the high level power source input terminal of the amplifier 514a becomes a voltage (Vcc+Va) corresponding to a sum of a voltage Va and a voltage Vcc, the voltage Va being supplied to the low level power source input terminal. In addition, the diode D7 is coupled between the capacitor C4 and the high level power source input terminal of the amplifier 514a so that the current flows in a single direction. In addition, the capacitor C3 maintains a voltage difference between the output terminal out of the amplifier 514a and the source of the transistor Xf. The operation of the gate driving circuit of FIG. 10 is described below.

When the control signal in becomes 5V to reduce the X electrode voltage Vx of the panel capacitor Cp in the period T3 of FIG. 3, the voltage of the output voltage out of the amplifier 514a becomes a voltage (15V+Va). Accordingly, since the gate-source voltage of the transistor Xf is 15V which is greater than the threshold voltage, the transistor Xf is turned on when it is in the normal state. Therefore, the LED D3 emits light since the current flows from the amplifier 514a to the gate of the transistor Xf through the LED D3.

When the transistor Xf has deteriorated, however, the transistor Xf is not driven. Therefore, when the control signal in is 5V, the LED D3 does not emit the light since a current path between the amplifier 514a and the gate of the transistor Xf is not formed.

In addition, when the control signal in is 0V, the output voltage out of the amplifier 514a is the voltage Va. The current flows to the low level power source input terminal of the amplifier 514a through the diode D4 since the gate-source voltage of the transistor Xf is 0V.

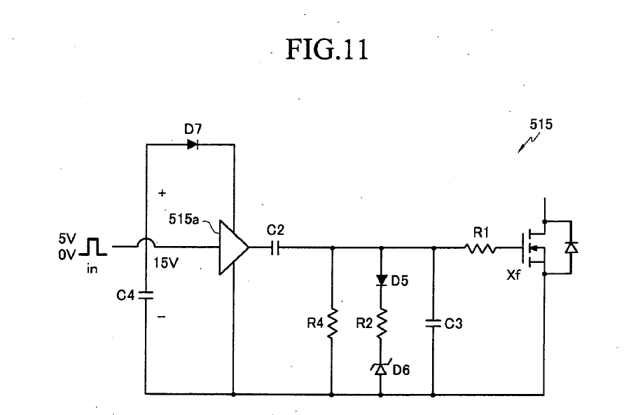

FIG. 11 is a schematic diagram of a gate driving circuit according to a fifth exemplary embodiment of the present invention.

As shown in FIG. 11, the gate driving circuit 515 according to the fifth exemplary embodiment of the present invention includes an amplifier 515a, capacitors C2, C3, and C4, an LED D5, a Zener diode D6, a diode D7, and resistors R1, R2, and R4. The operation of the gate driving circuit according to the fifth exemplary embodiment of the present invention is the same as that of the third and fourth exemplary embodiments of the present invention, and therefore a description of elements described above have been omitted.

According to the exemplary embodiment of the present invention, the operation state of the transistor Xf is determined by the light emitting state of the LED.

In addition to the gate driving circuit according to the first exemplary embodiment of the present invention, a different type of gate driving circuit can be realized when the LED is coupled between the amplifier and the gate or the source of the transistor Xf.

Furthermore, while the sustain pulse of the voltage Vs has been described as being alternately supplied to the X and Y electrodes as shown in FIG. 2 in the exemplary embodiment of the present invention, a sustain pulse alternately having a voltage Vs and a voltage −Vs as a voltage difference between the X and Y electrodes can be supplied to the X electrode and/or the Y electrode.

For example, the sustain pulse alternately having the voltage Vs and the voltage −Vs can be supplied to the X electrode while the Y electrode is biased at the ground voltage. In this case, a voltage level of the power source coupled to the power recovery capacitor C1 and transistors Xs and Xg must be changed.

In addition, while the power recovery circuit has been described as being used in the sustain period in the exemplary embodiment of the present invention, the power recovery circuit can be used in the address period. That is, an address pulse to be supplied to the A electrode in the address period can be generated using the power recovery circuit.

According to an exemplary embodiment of the present invention, the operation state of the power recovery circuit can be easily determined without needing high cost power by changing positions of the transistor and the LED. In addition, it can easily been determined whether the transistor has deteriorated according to an exemplary embodiment of the present invention.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A plasma display, comprising:
a plurality of electrodes extending in one direction;
at least one inductor coupled between the plurality of electrodes and a power recovery power source;
a first transistor coupled either between the at least one inductor and the electrode or between the at least one inductor and the power recovery power source;
a second transistor coupled either between the at least one inductor and the electrode or between the at least one inductor and the power recovery power source; and
a gate driving circuit adapted to supply either a high or low level voltage to a gate of either the first or second transistor, and including a Light Emitting Diode (LED) adapted to emit light in response to a current flow to the gate, and a first diode coupled to the LED in reverse parallel.

2. The plasma display of claim 1, wherein the gate driving circuit further comprises an amplifier adapted to output either the high level voltage or the low level voltage in response to a signal to control the transistor, and wherein the LED and the first diode are coupled in parallel between the amplifier and the gate of either the first transistor or the second transistor.

3. The plasma display of claim 2, wherein the gate driving circuit further comprises a first capacitor having a first terminal coupled to the amplifier and a second terminal coupled to the gate of either the first or the second transistor and a source thereof; and wherein the LED is coupled either between the amplifier and the capacitor or between the amplifier and the gate.

4. The plasma display of claim 2, wherein the LED comprises an anode coupled to the amplifier and a cathode coupled to the gate of either the first or the second transistor and the source thereof; and wherein the first diode comprises a cathode coupled to the amplifier and an anode coupled to the gate of either the first or the second transistor and the source thereof.

5. The plasma display of claim 3, wherein the amplifier comprises a third transistor and a fourth transistor coupled between a first power source adapted to supply a first voltage and a second power source adapted to supply a second voltage, the third and fourth transistors arranged as a push-pull circuit; and wherein the amplifier is adapted to supply a driving voltage to the gate of either the first or the second transistor through the push-pull circuit.

6. The plasma display of claim 5, wherein one of the third and fourth transistors comprises an NPN transistor and the other of the third and fourth transistors comprises PNP transistor.

7. The plasma display of claim 5, further comprising:
a first resistor coupled between the second terminal of the first capacitor and the gate of either the first or the second transistor; and
a second resistor coupled between the second terminal of the first capacitor and the source of either the first or the second transistor.

8. The plasma display of claim 7, further comprising a second capacitor coupled between the second terminal of the first capacitor and the source of either the first or the second transistor.

9. The plasma display of claim 8, further comprising a third resistor coupled between the first terminal of the first capacitor and the second power source.

10. The plasma display of claim 8, further comprising a third capacitor having a first terminal adapted to supply the first voltage of the first power source and a second terminal to supply the second voltage of the second power source, the second terminal being coupled to the source of either the first or the second transistor, and the third capacitor being charged to a voltage corresponding to a difference between the first voltage and the second voltage.

11. The plasma display of claim 10, further comprising a second diode coupled between the first terminal of the third capacitor and the amplifier.

12. The plasma display of claim 1, further comprising:
a fifth transistor coupled between the electrode and a third power source adapted to supply a third voltage; and
a sixth transistor coupled between the electrode and a fourth power source adapted to supply a fourth voltage lower than the third voltage;
wherein the power recovery power source is adapted to supply a voltage between the third voltage and the fourth voltage.

13. The plasma display of claim 12, wherein the second voltage is of the same voltage level as that of the fourth voltage.

14. The plasma display of claim 1, wherein the first and second transistors respectively include a body diode, and wherein the plasma display device further comprises:
a second diode coupled to the first transistor in series in a reverse direction to the body diode thereof; and
a third diode coupled to the second transistor in series in a reverse direction to the body diode thereof.

15. A plasma display, comprising:
a plurality of electrodes extending in one direction;
at least one inductor coupled between the plurality of electrodes and a power recovery power source;
a first transistor coupled between either the at least one inductor and the electrode or between the at least one inductor and the power recovery power source;
a second transistor coupled between either the at least one inductor and the electrode or between the at least one inductor and the power recovery power source; and
a gate driving circuit adapted to supply either a high or low level voltage to a gate of either the first or second transistor, and including a Light Emitting Diode (LED) coupled between the gate and the source of either the first or second transistor and adapted to emit light in response to a current flow to the gate.

16. The plasma display of claim 15, wherein the gate driving circuit further comprises an amplifier adapted to output either the high level voltage or the low level voltage in response to a signal to control the transistor; and wherein the LED is coupled between the amplifier and the source.

17. The plasma display of claim 16, wherein the gate driving circuit further comprises:
a first capacitor having a first terminal coupled to the amplifier and a second terminal coupled to the gate and a source of either the first or the second transistor; and
a first resistor coupled to the second terminal of the first capacitor and the source of either the first or the second transistor.

18. The plasma display of claim 17, wherein a cathode of the LED is coupled to the source of either the first or the second transistor, and wherein an anode of the LED is coupled to the second terminal of the first capacitor.

19. The plasma display of claim 17, further comprising:
a second resistor coupled between the second terminal of the first capacitor and the gate of either the first or the second transistor; and
a third resistor coupled between the second terminal of the first capacitor and the source of either the first or the second transistor.

20. The plasma display device of claim 19, further comprising a second capacitor coupled between the second terminal of the first capacitor and the source of either the first or the second transistor.

21. The plasma display of claim 18, further comprising a Zener diode coupled between the LED and the source of either the first or the second transistor.

22. The plasma display of claim 21, wherein the Zener diode has a cathode coupled to the cathode of the LED and an anode coupled to the source of either the first or the second transistor.

23. The plasma display of claim 20, further comprising a fourth resistor coupled between the first terminal of the first capacitor and the ground power source.

24. The plasma display of claim 22, further comprising a third capacitor having a first terminal adapted to supply the first voltage of the first power source to a high level power input terminal of the amplifier and a second terminal to supply the second voltage of the second power source to a low level power input terminal of the amplifier; wherein the capacitor is charged to a voltage corresponding to a difference between the first voltage and the second voltage; and wherein the second terminal of the capacitor is coupled to the source of either the first or second transistor.

25. A driver for driving a plasma display having a plurality of electrodes extending in a single direction, the driver comprising:
a gate driving circuit including:
at least one inductor coupled to the plurality of electrodes;
a first transistor coupled to the at least one inductor and adapted to increase a voltage at the electrode when the first transistor is turned on;
a second transistor coupled to the at least one inductor and adapted to reduce the voltage at the electrode when the second transistor is turned on;
a Light Emitting Diode (LED) coupled to a gate of either the first or the second transistor and adapted to emit light in response to either the first or the second transistor being turned on; and
a diode coupled to the gate of either the first or the second transistor, the diode being coupled in reverse parallel with the LED.

26. The driver of claim 25, wherein the gate driving circuit further comprises an amplifier adapted to receive a signal to control a turn on of either the first or the second transistor, to control an output a predetermined voltage, and to control the emission of light from the LED.

27. The driver of claim 25, further comprising:
a third transistor adapted to be turned on in response to the voltage at the electrode being increased, the third transistor supplying a first voltage to the electrode; and
a fourth transistor turned adapted to be turned on in response to the voltage at the electrode being reduced, the fourth transistor supplying a second voltage which is less than the first voltage.

28. The driver of claim 26, further comprising:
a third transistor adapted to be turned on in response to the voltage at the electrode being increased, the third transistor supplying a first voltage to the electrode; and
a fourth transistor turned adapted to be turned on in response to the voltage at the electrode being reduced, the fourth transistor supplying a second voltage which is less than the first voltage.

29. The driver of claim 27, further comprising a capacitor adapted to be charged to a voltage between the first voltage and the second voltage, the capacitor being coupled between the first transistor and the second transistor.

30. The driver of claim 28, further comprising a capacitor adapted to be charged to a voltage between the first voltage and the second voltage, the capacitor being coupled between the first transistor and the second transistor.
